(19) United States
(12) Patent Application Publication
(10) Pub. No.: US 2008/0195482 A1
(43) Pub. Date: Aug. 14, 2008

(54) METHOD AND SYSTEM FOR PROVIDING REMOTE TRANSLATIONS

(75) Inventor: Tony Stephen Sailer, San Diego, CA (US)

Correspondence Address: BRINKS HOFER GILSON & LIONE, P.O. BOX 10395, CHICAGO, IL, 60610, US

(73) Assignee: Enterpret Communications, Inc., San Diego, CA (US)

(21) Appl. No.: 11/870,505

(22) Filed: Oct. 11, 2007

Related U.S. Application Data
(60) Provisional application No. 60/850,924, filed on Oct. 11, 2006.

(51) Int. Cl. G06Q 30/00

(52) U.S. Cl. 705/14

(57) ABSTRACT

A method and system for enabling a user at a remote location to obtain various types of translation services. The user utilizes a remote device to communicate with a translation engine to perform text-to-text, text-to-voice, and voice-to-voice translations. Advertisements can be provided to the user in connection with the translations.

### CROSS-REFERENCE TO RELATED APPLICATIONS

This application claims the benefit of U.S. Provisional Application No. 60/850,924, the entirety of which is hereby incorporated by reference.

### BACKGROUND

The present invention relates generally to translation services and more particularly to providing translations to remote locations.

Systems and methods for providing translation services to remote locations exist in several forms. One form is an Internet based system that utilizes a standard web browser. One problem with this type of system is that it requires that a complete web browser be installed on a user's device, which uses a significant amount of memory and can cause a slowdown in the operation of the device. A second form is a mobile translation dictionary where all of the information needed to perform a translation, including a translation database is stored on the user's device, which can be a cellular telephone, a personal digital assistant (PDA), etc. This type of translation service utilizes a lot of memory on the user's device, is limited in its translation capabilities, and is limited in its expansion capabilities due, primarily, to memory limitations. Also, these types of translation services are generally not considered to be very accurate as they try to use one translation engine to translate all languages.

A third form of translation service requires a user to send a message to a specific location that is dedicated to a specific language translation pair in order to have the proper translation performed. Thus, if the user wishes to have a phrase translated from English to Spanish, they must send the phrase to a specific location that handles English to Spanish translations. If the user wishes to have the same phrase translated from English to French, they must send the phrase to a different, specific location that handles English to French translations. This type of system is cumbersome to use as it requires the user to identify the specific destination location in advance of requesting the translation and the requested translation will not occur if the user sends the message to the wrong location. A fourth form of translation service consists of a hand held device that is manufactured solely for the purpose of providing translations and wherein the entire translation program is located on the device. These devices are limited in their translation capabilities and are limited in their expansion capabilities due, primarily, to memory limitations. Also, these devices are generally not considered to be very accurate as they try to use one translation engine to translate all languages. In addition, because these devices are dedicated to only providing translations, the do not provide the user with capabilities such as email, cellular telephone, calendar, etc. A system and a method that overcome these deficiencies are needed.

### BRIEF DESCRIPTION OF THE DRAWINGS

FIG. 1 is a block diagram of a translation system of a preferred embodiment.

FIG. 2 is a block diagram of a method of performing a translation of a preferred embodiment.

FIG. 3 is a depiction of a user interface for use in a system and method for performing a translation.

FIG. 4 is a depiction of a user interface for use in a system and method for performing a translation.

FIG. 5 is a depiction of a user interface for use in a system and method for performing a translation.

FIG. 6 is a depiction of a user interface for use in a system and method for performing a translation.

FIG. 7 is a depiction of a user interface for use in a system and method for performing a translation.

FIG. 8 is a depiction of a user interface for use in a system and method for performing a translation.

FIG. 9 is a depiction of a user interface for use in a system and method for performing a translation.

FIG. 10 is a depiction of a user interface for use in a system and method for performing a translation.

FIG. 11 is a depiction of a user interface for use in a system and method for performing a translation.

FIG. 12 is a depiction of a user interface for use in a system and method for performing a translation.

FIG. 13 is a depiction of a user interface for use in a system and method for performing a translation.

FIG. 14 is a depiction of a user interface for use in a system and method for performing a translation.

FIG. 15 is a depiction of a user interface for use in a system and method for performing a translation.

FIG. 16 is a depiction of a user interface for use in a system and method for performing a translation.

FIG. 17 is a depiction of a user interface for use in a system and method for performing a translation.

FIG. 18 is a depiction of a user interface for use in a system and method for performing a translation.

FIG. 19 is a depiction of a user interface for use in a system and method for performing a translation.

FIG. 20 is a depiction of a user interface for use in a system and method for performing a translation.

FIG. 21 is a depiction of a user interface for use in a system and method for performing a translation.

FIG. 22 is a depiction of a user interface for use in a system and method for performing a translation.

FIG. 23 is a depiction of a user interface for use in a system and method for performing a translation.

FIG. 24 is a depiction of a user interface for use in a system and method for performing a translation.

FIG. 25 is a depiction of a user interface for use in a system and method for performing a translation.

FIG. 26 is a depiction of a user interface for use in a system and method for performing a translation.

FIG. 27 is a depiction of a user interface for use in a system and method for performing a translation.

FIG. 28 is a depiction of a preferred embodiment of a message for communicating between a remote device and a server for use in a system and method for performing a translation.

### DETAILED DESCRIPTION OF THE PRESENTLY PREFERRED EMBODIMENTS

By way of introduction, the preferred embodiments described below include a method and system for enabling a user at a remote location to obtain various types of translation services. In one embodiment, a user is able to request and receive translations via a remote device such as a cellular telephone, a personal digital assistant (PDA), a portable computer, or another form of portable communication device. The user utilizes the remote device to communicate with a remote server based translation engine, and a corresponding database, which can provide text-to-text, text-to-voice, and voice-to-voice translation services. The server based translation engine and the corresponding database can implement one or more translation pairs, which enables the engine to translate words or phrases between the different translation pairs. For each translation pair, the translation engine and/or the database stores a term bank that facilitates the translations. The translation engine also allows a user to look up words in a dictionary, conjugate verbs in all 17 tenses, and use a Thesaurus in the user's source language. The translation engine is scalable such that additional language translation pairs and additional terms and term banks can be added to the engine.

The communication of the user's translation request, as well as the response to the user, can occur via a networked connection, such as a cellular network, a broadband network, or the Internet, using a suitable communication protocol. The translation can be provided to the user in a text format and it can also be provided in a voice format via an audio file, such as a .wav file, etc., which the user can listen to on their remote device The translation received by the user can be saved on the remote device for later access. This is true for both the text and voice versions of the translation. The user can also connect to a live operator for live voice-to-voice translation services via a voice over Internet (VoIP) connection or via a cellular or other type of connection. By utilizing a remote server based translation engine, the method and system provide scalability, which allows for a large, and potentially unlimited, database for translations. This, in turn, has many benefits, including the ability to provide translations for virtually unlimited language translation pairs, better accuracy in translations, and better efficiency in terms of the amount of time it takes to complete a translation. In addition, the systems and methods described herein can provide seamless on-the-fly translation within applications such as wireless applications, chat, instant messaging (IM), email, and short messaging service (SMS).

In another embodiment, the present system and method allow for advertisements to be provided to the user along with their requested translations. The advertisements can be delivered to the user's remote device in text, audio, and/or video formats utilizing, for example .jpg, .gif, or streaming video formats. The advertisements can be based on the user's demographics and/or the content of the translation that the user is seeking.

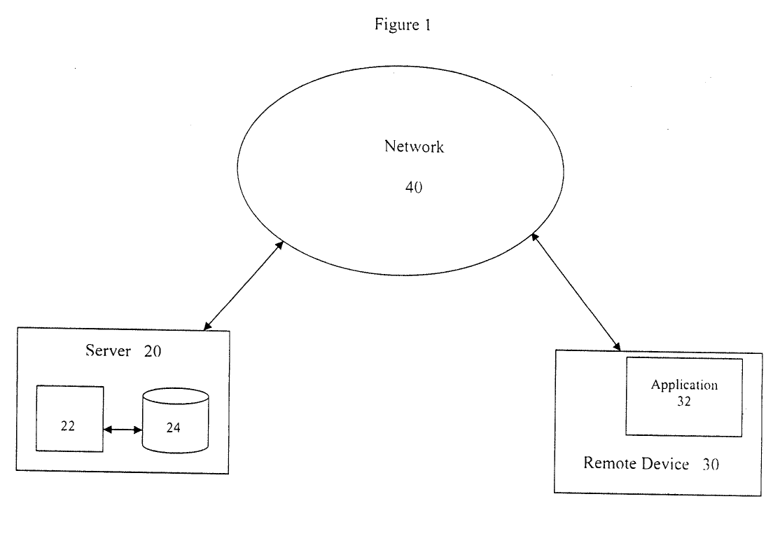

By way of example, FIG. 1 shows a block diagram of a system for providing translations according to a preferred embodiment. The system comprises a server 20 that can communicate with a remote device 30 via a network 40. The server 20 can comprise a single server, or it can comprise multiple servers or one or more server farms that are located in one or more locations around the world.

The server 20 preferably implements a translation engine 22 that communicates with a database 24 that can store language or translation pairs that enable machine-based translations to be completed in an efficient and effective manner. In a preferred embodiment, the server 20 stores more than 100 million terms or words per language/translation pair, which enables the system 100 to dramatically improve machine translation to near 100% accuracy. In another embodiment, the server 20 stores approximately 20 million terms or words per language/translation pair, which enables the system to achieve near 95% translation accuracy per language pair. In another embodiment, the server 20 and the application 32 can provide machine implemented voice-to-voice translation using 300 million terms per language pair being stored in the server 20, database 24, and/or term bank. The presently preferred platform for the server 20 is an Apache Tomcat platform, and the presently preferred translation engine is based on a software development kit (SDK) available from Word Magic.

The server 20, preferably, stores all of the translations that are performed at the server in a “term bank.” The term bank can be stored in the database 24 or can be stored apart from the database. Via the term bank, the server 20 and/or the translation engine 22 are able to index or lookup words, phrases, etc. for translation. The term bank also enables the server 20, the translation engine 22, and/or a person to change the meaning of the translations, for example as necessary to comply with regional dialects, via human review and correction or modification of the translations. This allows for the personalization of translations performed for a user based upon the prior preferences of the user, and it also allows for the predefining of translations and meanings for any word or phrase. For example, a user can select either UK English or American English or regionalized Latin American Spanish or Castilian Spanish.

The server 20, the translation engine 22, the database 24, and the term bank are scalable in that additional language pairs can be easily and efficiently added. In a preferred embodiment, the system can include a suite of translation tools and/or data that enable translations among virtually any language pairs, include among the following languages: English, Spanish, French, Italian, German, Russian, Chinese and Japanese.

The server 20 and/or the translation engine 22 also preferably implement a dictionary look-up function, a verb conjugator function, a thesaurus function, as well as text-to-text and text-to-voice translation services, as described herein.

To perform a translation, a dictionary lookup, a thesaurus search, etc., the translation engine 22 receives a communication from the remote device that indicates the word or phrase that is to be acted upon, as well as an indication of the language/translation pair that is applicable to this requested action. In response to the communication, the translation engine 22 accesses the database 24 or the term bank to determine the proper translation, dictionary lookup, or thesaurus reference, for the word or phrase communicated to the server 20. This can be accomplished via indexing, lookups, etc. as know by those skilled in the art. Due to the remote server implementation, all of these services can be accessed and can provide a completed translation in less than 2 seconds.

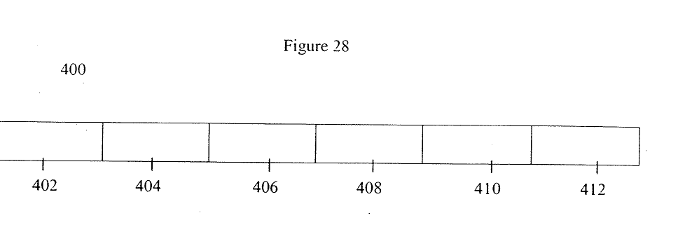

To achieve this operation, a java applet running on the server preferably parses the communication received from the remote device 30, calls the necessary functions, and provides the data necessary to perform the required action. The presently preferred format of the message sent from the remote device 30 to the server 20 is a binary string 400 having six fields, as shown in FIG. 28. One of the fields is a standard header 402, as required by a given application programming interface (API). Another field is a URL address 404 for the application that is to be accessed to perform the translation. In the present example the address would be the URL address for the translation engine 22. Another field is a key 406 that can be used as a security or feature to prevent unauthorized users from accessing the system 100. In a preferred embodiment, the key 406 can be generated by performing a hash function on data associated with the user, such as information from the user's profile or demographics. This key can be stored on both the server 20 and the remote device 30 and can be used by the server to access a database or lookup table to determine if the key is valid and also whether the user sending the key is allowed to access the system 100. Other types of security and access control systems and methods can be used in the present application. Another field is the language field 408 that indicates the translation/language pair to be used for a given action. This field can comprise one or more bits that signify the language pair to be used. In alternative embodiments, and one or a combination of the following can be used to signify the language pair, bits, bytes, words, numbers, letters, symbols, and the like. Another field is the word or phrase field 410 that indicates the word or phrase that is to be translated, etc. In alternative embodiments, some of these fields can be eliminated and one or more additional fields 412 can be added. The return message to the remote device can also comprise a binary string with header information and the resulting translated information. Other forms and formats for communication between the remote device 30 and the server 20 can be used in conjunction with the present invention.

In a preferred embodiment, the server 20 can store advertisements that can be transmitted to the remote device 30 for display or playing thereon. The advertisements can be video, still images, audio, and/or text messages and can be selected based upon the user's demographics and/or based upon the content of the translation. Revenue generated as a result of advertising sent along with the translation services can be shared amongst various entities.

In an alternative embodiment, different levels of service can be provided to the user based upon the user's preference. For example, if the user does not demand a high level of accuracy, a translation or other action can be performed using a database or term bank that is limited in its content. This may allow for a faster transaction. Alternatively, if the user demands a high level of accuracy for a translation, a bigger or more robust database or term bank may be used to perform the translation or other action.

The remote device 30 preferably comprises a device that is capable of communicating with a network such that data can be transmitted and received between the remote device 30 and the network 40. Examples of suitable remote devices include, but are not limited to, cellular telephones, personal digital assistants (PDAs), portable computers, and portable communication devices, such as the Blackberry devices available from Research In Motion (RIM), the Q product available from Motorola, and the devices available from Treo. or any other form of communication device adapted for use in the present embodiments.

The remote device 30 preferably implements an application 32 that works in conjunction with the server 20 to provide the translation services described herein. The application 32 can be downloaded from a website, and the application 32 can be obtained free or charge to a user or the user can be required to pay a fee for the application. The fee could be a one time purchase fee or some type of ongoing payment of a monthly fee or a fee for the use of the application for some other time period. Alternatively, the application 32 can be included on a remote device when the user purchases the remote device. In this scenario, the application can be provided free of charge, or the remote device provider may pay some sort of fee, such as those discussed above.

The application 32 preferably implements a dictionary look-up function, a verb conjugator function, a thesaurus function, as well as text-to-text, text-to-voice, and live translation services, as described herein. In addition, the application 32 preferably allows a user to save translations on their remote device 30 and retrieve them in the future. The application 32 also, preferably, enables the user to forward the translations received from the server 20 to other locations. In one preferred embodiment, the translations can be forwarded as an SMS message. The application 32 also preferably implements a “talk to translator” function, which enables live voice translation via a communication protocol, such as voice over Internet protocol (VoIP) or a cellular connection, which enable the user to speak directly to a translator via the user's remote device 30. The presently preferred embodiment of the application 32 is written in java. However, the application can also be written in Simbian and Brew to allow for use on devices that utilize the 2G/3G communication protocol.

In a preferred embodiment, advertisements can be displayed or played on remote device 30 in the form of text, audio, still images, and/or video.

In a preferred embodiment, the user can access a web page, using a personal computer or other device, to complete the demographic information or user profile. The user can provide information about their age, sex, address, family members, native language, interests, hobbies, etc., as well as providing credit card or other payment information. This website can be accessed through a password protected portal. The user can also access their profile to update it at any time. As described herein, the demographic information can be used to provide personalized services or advertisements as described herein.

The network 40 preferably comprise a cellular network, but it can also comprise one or a combination of virtually any type of network, including cellular, wireless, broadband, plain old telephone system (POTS), local area network (LAN), wide area network (WAN), Internet, etc.

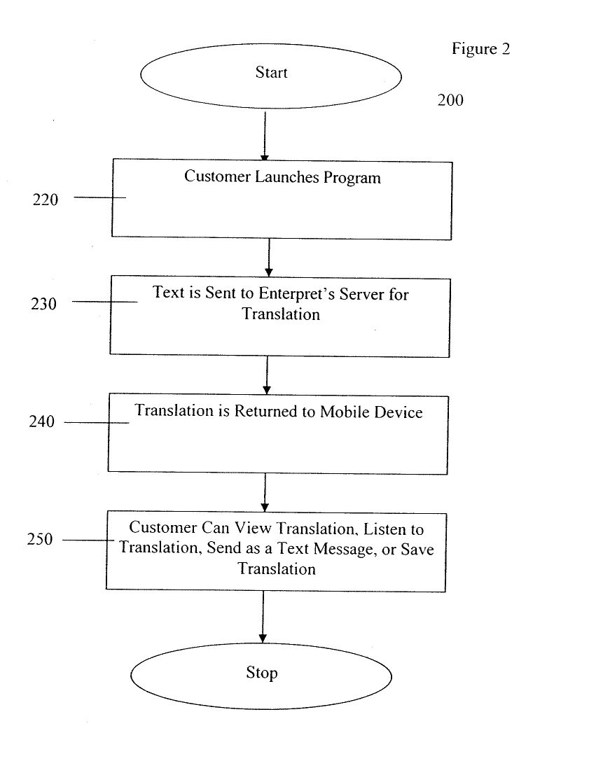

The system shown in FIG. 1 and described herein can be used to implement the method 200 shown in FIG. 2. As shown in box 220, the user launches the application 32 on their remote device 30. After the user has selected their desired action, as discussed in more detail below, a message is sent to the server 20, as shown in box 230. After the desired action is performed at the sever 20, a translation is returned to the remote device 30, as shown in box 240. Thereafter, the user can perform several additional actions, some of which are shown in box. 250. Preferred implementations of this method are described further below.

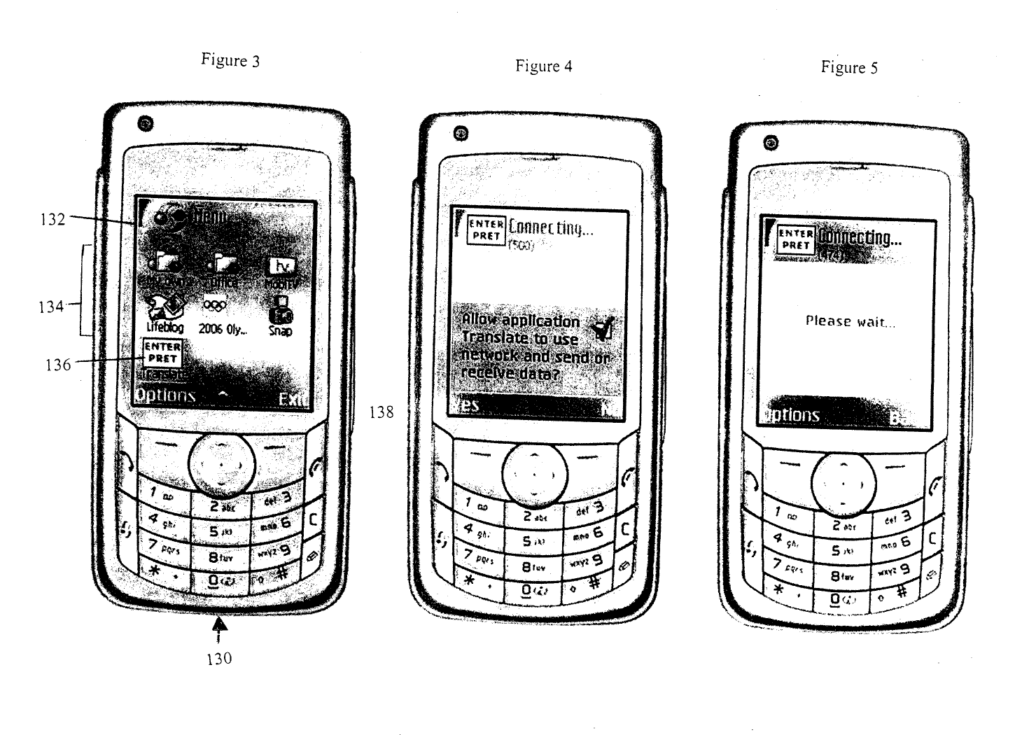

Referring now to FIGS. 3-27, methods for performing translations and other actions according to the presently preferred embodiments are shown and are described below. FIG. 3 depicts a remote device, in this case a cellular telephone 130. The screen 132 shows several icons for applications 134, including an icon 136 for a translation application as described herein. When a user selects the icon 136, a message can be displayed, as shown in FIG. 4. This message can request that the user to allow the application to send and receive data via a network can be displayed. If the user answers “Yes,” by selecting the yes option 138, the message shown in FIG. 5 can be displayed to the user while the device 130 is attempting to communicate with the server 20. Once communication between the remote device 130 and the server 20 is established, a welcome screen, such as the one shown in FIG. 6 can be displayed to the user. After the display of the welcome screen in FIG. 6, an advertisement, such as the one shown in FIG. 7 can be displayed to the user. The messages shown in FIGS. 4-6 are optional as they need not be displayed to the user.

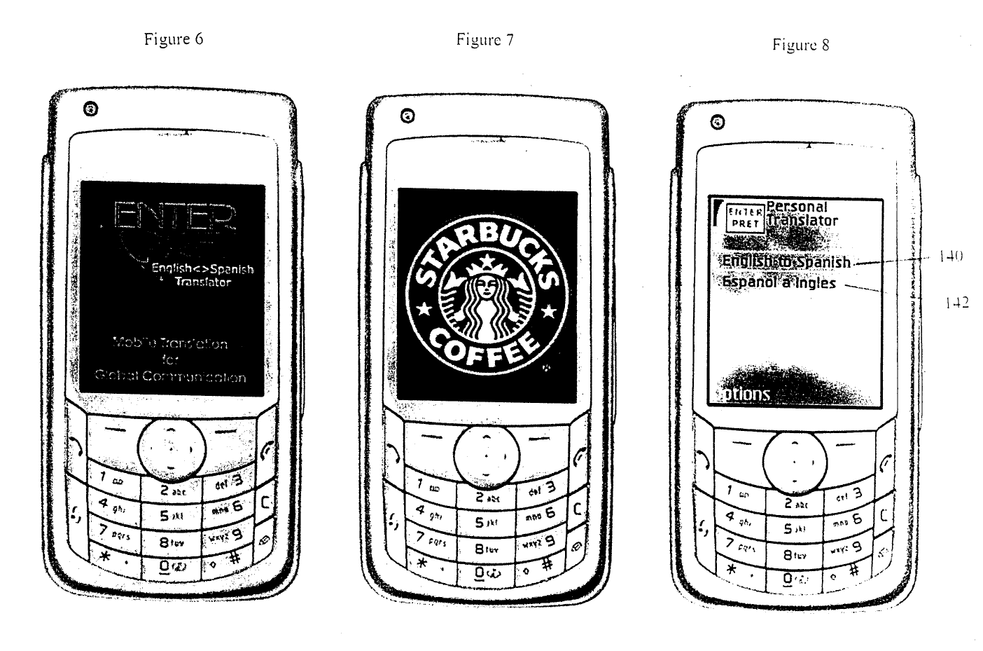

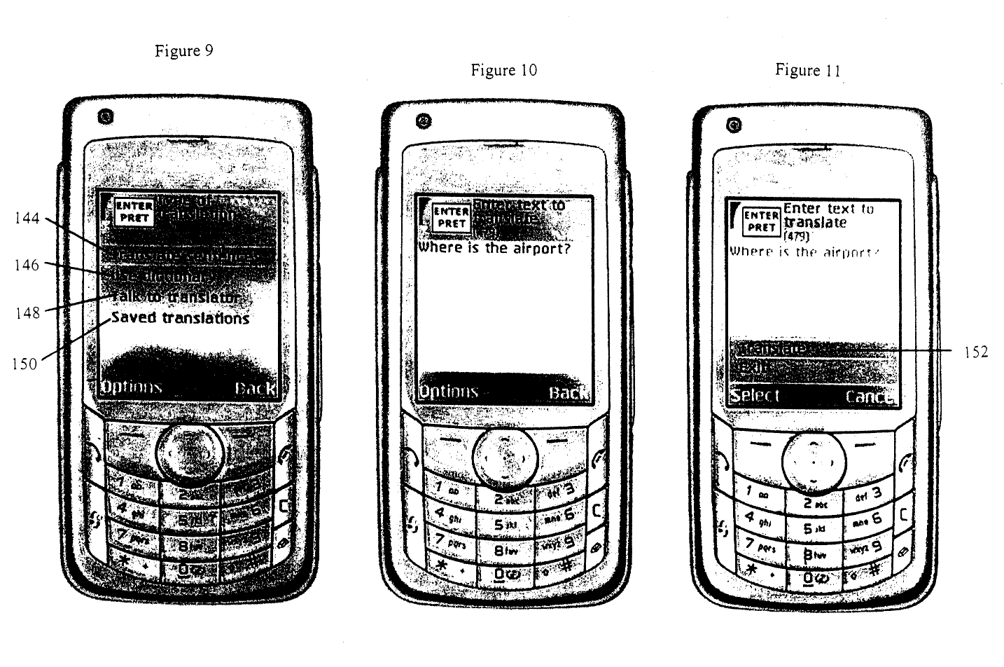

As shown in FIG. 8, a message listing translation options is preferably displayed to the user. The specific example shown in FIG. 8 provides only a two translation options—English to Spanish 140 and Spanish to English 142. In alternative embodiments, a similar display listing numerous translation options can be provided to a user. The user can select from the two options shown in FIG. 8 to indicate their desired translation. After the user has done so, they can be presented with a number of translation options, as shown in FIG. 9. In this example, the options include Translate Sentences 144, Use Dictionary 146, Talk to Translator 148, and Saved Translations 150. In alternative embodiments some of these options may not be displayed, while other options may be displayed.

If the user selects the “Translate Sentences” option 144, the screen shown in FIG. 10 is preferably displayed. In this screen, the user can enter a word or phrase, such as “Where is the airport?” as shown in FIG. 10. The user can enter this information by typing it or speaking it. Once the information has been entered, the user is able to request a translation by selecting the “Translate” option 152 as shown in FIG. 11. Selecting this option causes a message to be send from the remote device to the server 20. The preferred format of this message is disclosed above. When the message is received by the server 20, the server can take one or more actions as described herein.

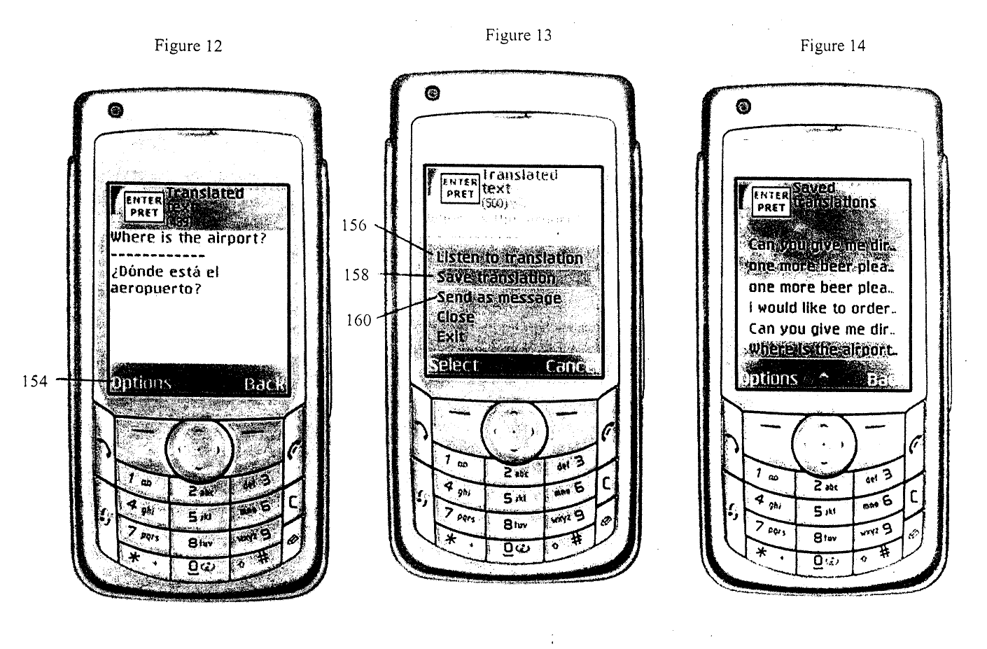

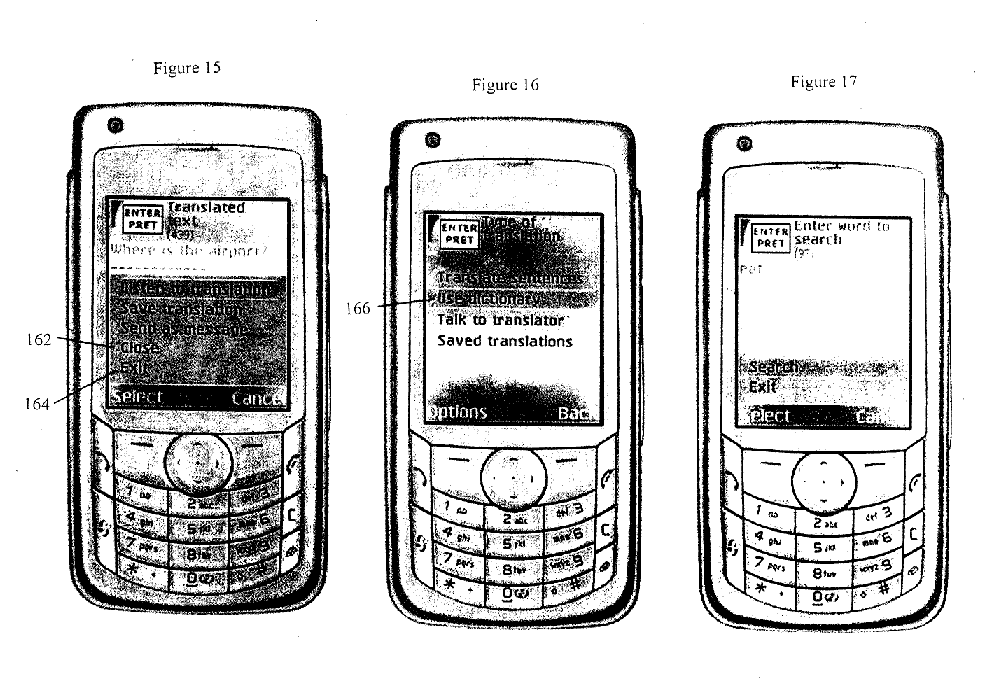

In this example, a translation is prepared at the server 20, is transmitted back to the remote device 130, and then that translation is preferably displayed on the remote device, as shown in FIG. 12, along with an “Options” feature 154 that enables the use to see additional options. If the user selections the “Options” feature 154, the menu shown in FIG. 13 can be displayed. The user can then select the “Listen to Translation” option 156. The user can also select the “Save Translation” option 158, which enables the translation, both text and audible formats, can be saved on the user's remote device 130. As shown in FIG. 140, the user can access other saved translations and can review them, hear them, or delete them at any time. The user can also select the “Send as Message” option 160 that enables the user to send the translation on to another person. In response to this selection, a message is created using an SMS format that includes the text version of the translation for sending to another location. The message can also include an audio file for the translation as an attachment. The user can also select the “Close” option 162, as shown in FIG. 15, which closes the options menu, as well as selecting the “Exit” option 164, which causes the application to exit.

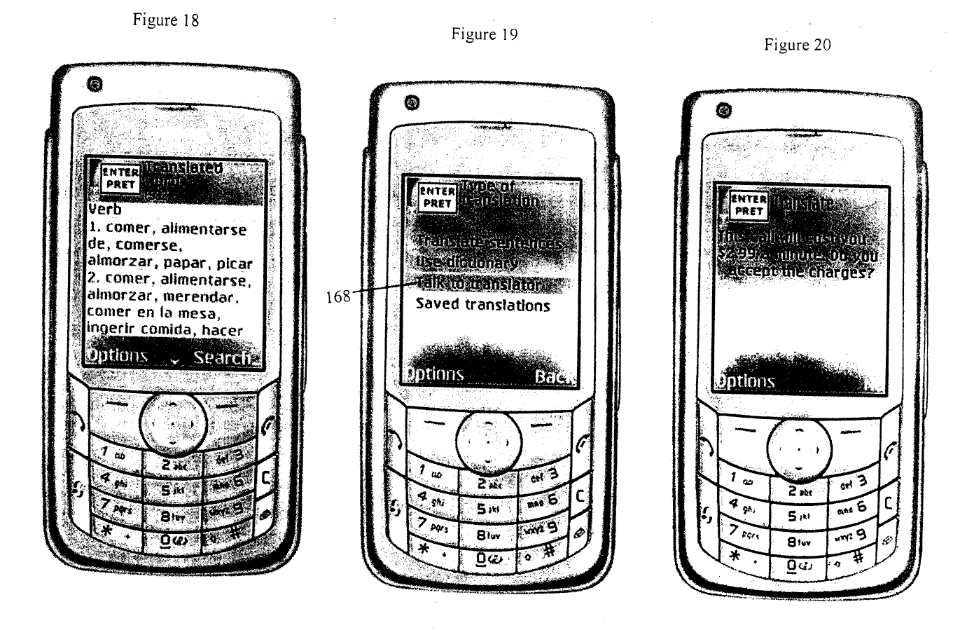

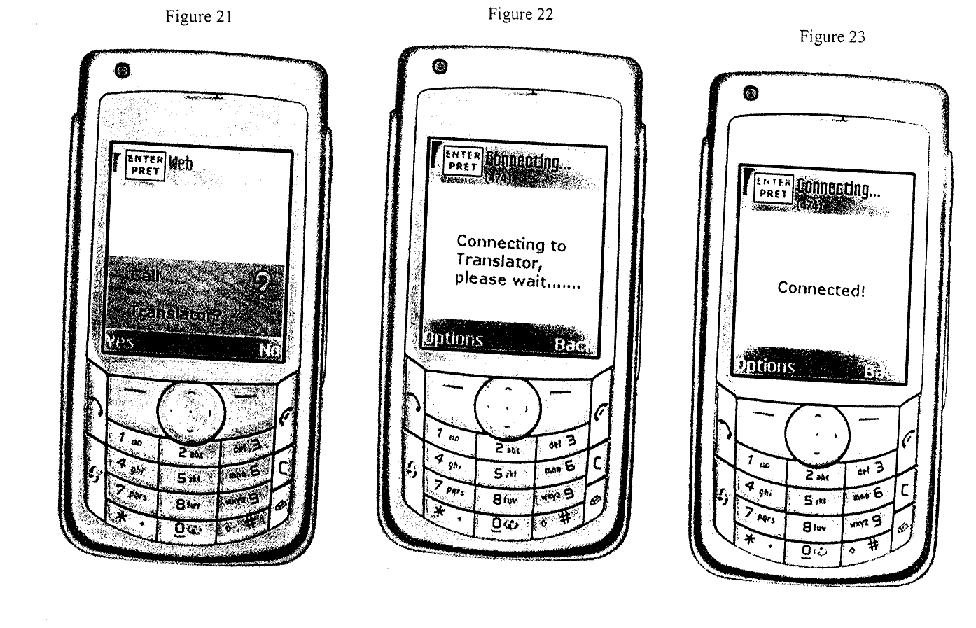

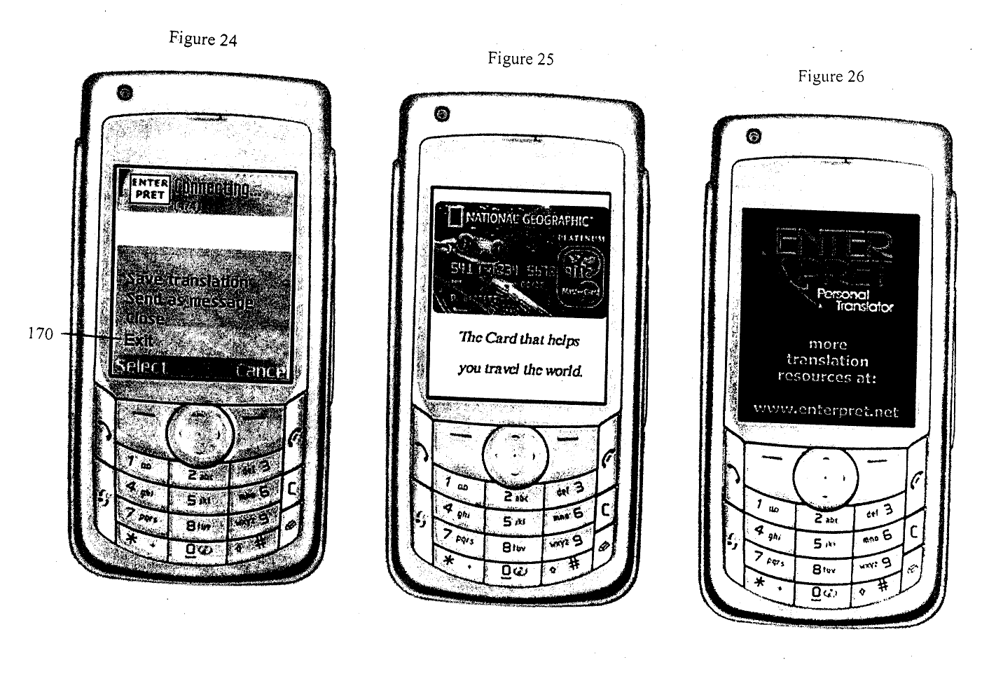

Referring back to one of the original pages, the user can select the “Use Dictionary” option 166, as shown in FIG. 16. After that option has been selected, the user is presented with screen that enables the user to look up certain terms in a dictionary, such as “eat,” as shown in FIG. 17. FIG. 18 shows the results of a dictionary look up of “eat” performed at the server 20. As shown in FIG. 19, a user can also select the option to “Talk to Translator” 168. The selection of this option can result in the generation of the screen shown in FIG. 20, which identifies the cost of the intended communication. The user can then be shown the screen shown in FIG. 21 that asks the user to confirm that they are willing to incur that cost. If the user confirms that they are willing to pay the cost, a call or other type of communication is initiated to the translator. If there is a delay in connecting to the translator, the screen shown in FIG. 22 can be displayed, and then the screen shown in FIG. 23 can be displayed when the connection has been made. Once connected, the user can speak with the translator to obtain translations.

In a preferred embodiment, the connection with the translator is established according to the following. Once the user has accepted the charges, the user is connected to a computer or an interactive voice response system (IVR) located in the country that he is calling from. The computer answers in the language that has been pre-set for the user's phone based on the user's preferences and profile. A digital voice asks you what language pair you would like to translate. From here, the computer automatically routes the call to an interpreter that is a member of a global translation community. The call is routed via VOIP technology (Voice Over Internet Protocol) (such as SKYPE) and the user is then connected to a live translator and can begin the translation process.

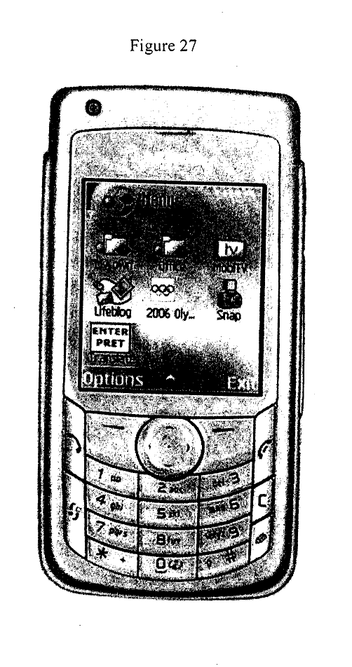

As shown in FIG. 24, the user can select the “Exit” 170 option which causes the program to exit. At this point, a second advertisement can be displayed to the user, as shown in FIG. 25. After the advertisement is shown, the screen shown in FIG. 26 can be displayed as the program exits, before returning to the device's main menu as shown in FIG. 27.

In an alternative embodiment, a word of the day feature can be provided using the system 100. In this embodiment, the server 20 or the translation engine 22 can select a specific word of the day that can be viewed by a user when they access the service, as shown in FIG. 6. The word of the day, and the corresponding translation, can be show in the user's preferred language pair and can be displayed after the display of an advertisement, such as after the display shown in FIG. 7.

In a further alternative embodiment, a user can access the server 20 or the translation engine 22 via the Internet through a website. This makes all of the functionality of the server 20 and/or the translation engine 22 available to the user via the Internet. In this example, an ASP web form can be displayed to the user that enables the user to provide all of the information necessary to perform a translation, dictionary lookup, thesaurus, etc. The information provided by the user via the web form can be provided to the translation engine to enable it to perform the requested action. In response, the result can be displayed to a user via a webpage, and all of the additional functionality described herein can also be provided to the user.

The potential uses of the translation services disclosed herein are numerous. The translation services can be used in conjunction with giving or receiving directions or instructions, such as driving directions, ordering food, and other forms of basic communication where meaning is important, such as conveying information or instructions to employees who have a different native language. The translation services can also be used for casual translation for inter-office text messaging, text-to-text, text-to-voice, and other forms of communication requiring a lesser degree of accuracy. In addition, the translation services can be used to for complex and important translations where accuracy is paramount. These types of translations can involve the translation of technical documentation or information, legal documents or information, merger and acquisition related documents or information, politically related documents and information, government bids, etc.

The features and functions described above are preferably implemented through the use of computer readable program code written in any suitable programming language and implemented on an analog or digital computer utilizing any suitable operating system. Alternatively, the features and functions described above can be implemented through the use of hardware in the form of a hardwired computer, an integrated circuit, circuitry, or a combination of hardware, circuitry, and/or computer readable program.

It is to be understood that a wide range of changes and modifications to the embodiments described above will be apparent to those skilled in the art and are contemplated. It is therefore intended that the foregoing detailed description be regarded as illustrative rather than limiting.

I claim:

1. A method of providing a translation, the method comprising:
(a) receiving, via a dedicated application, a translation request that includes at least one word in a first language;
(b) translating the at least one word from the first language to a second language;
(c) identifying an advertisement; and
(d) transmitting the at least one word in the second language and the advertisement.

2. The method of claim 1, wherein the translation request further includes an indication of the second language.

3. The method of claim 1, wherein the at least one word comprises a single word.

4. The method of claim 1, wherein the at least one word comprises a phrase.

5. The method of claim 1, wherein the at least one word comprises a sentence.

6. The method of claim 1, wherein the at least one word is in an audible format.

7. The method of claim 1, wherein the at least one word is in a text format.

8. The method of claim 1, wherein (c) comprises identifying an advertisement based upon the at least one word.

9. A method of providing a translation, the method comprising:
(a) receiving information about a user;
(b) receiving, from the user, a translation request that includes at least one word in a first language;
(c) translating the at least one word from the first language to a second language;
(d) identifying an advertisement based on the information about the user; and
(e) transmitting, to the user, the at least one word in the second language and the advertisement.

10. The method of claim 9, wherein the translation request further includes an indication of the second language.

11. The method of claim 9, wherein the at least one word comprises a single word.

12. The method of claim 9, wherein the at least one word comprises a phrase.

13. The method of claim 9, wherein the at least one word comprises a sentence.

14. The method of claim 9, wherein the at least one word is in an audible format.

15. The method of claim 9, wherein the at least one word is in a text format.

16. The method of claim 9, wherein (a) comprises receiving demographic information about the user.

17. The method of claim 9, further comprising storing the information about the user.

18. A computer-readable storage medium comprising:
operational instructions that, when executed by a processor, cause the processor to receive information about a user;
operational instructions that, when executed by the processor, cause the processor to receive, from the user, a translation request that includes at least one word in a first language;
operational instructions that, when executed by the processor, cause the processor to translate the at least one word from the first language to a second language;
operational instructions that, when executed by the processor, cause the processor to identify an advertisement based on the information about the user; and
operational instructions that, when executed by the processor, cause the processor to transmit, to the user, the at least one word in the second language and the advertisement.

19. The computer-readable storage medium of claim 18, further comprising operational instructions that, when executed by the processor, cause the processor to store the information about the user.

20. The computer-readable storage medium of claim 19, further comprising operational instructions that, when executed by the processor, cause the processor to access the stored the information about the user in order to identify the advertisement based on the information about the user.
